(19) United States
(12) Patent Application Publication
(10) Pub. No.: US 2019/0345937 A1
(43) Pub. Date: Nov. 14, 2019

(54) REFRIGERANT PIPE AND REFRIGERATION CYCLE DEVICE

(71) Applicant: DENSO CORPORATION, Kariya-city (JP)

(72) Inventor: Shuichi SATO, Kariya-city (JP)

(21) Appl. No.: 16/524,399

(22) Filed: Jul. 29, 2019

Related U.S. Application Data
(63) Continuation of application No. PCT/JP2018/001845, filed on Jan. 23, 2018.

(30) Foreign Application Priority Data
Feb. 7, 2017 (JP) 2017-020265

(51) Int. Cl. F04C 23/00; F25B 41/00; F25B 30/02; B60H 1/00

(52) U.S. Cl. CPC F04C 23/008; B60H 1/00899; F25B 30/02; F25B 41/003

(57) ABSTRACT

A refrigerant pipe according to an aspect of the present disclosure includes a flow dividing portion, a first passage, a second passage, and a flow joining portion. The flow dividing portion divides a flow of a refrigerant on an outlet side of an evaporator of a refrigeration cycle and on an inlet side of a compressor of the refrigeration cycle. The refrigerant divided at the flow dividing portion flows through the first passage and the second passage in parallel with each other. The refrigerant flowing through the first passage and the refrigerant flowing through the second passage join together at the flow joining portion. The first passage and the second passage are different in flow path length from each other.

### CROSS REFERENCE TO RELATED APPLICATIONS

The present application is a continuation application of International Patent Application No. PCT/JP2018/001845 filed on Jan. 23, 2018, which designated the United States and claims the benefit of priority from Japanese Patent Application No. 2017-020265 filed on Feb. 7, 2017. The entire disclosures of all of the above applications are incorporated herein by reference.

### TECHNICAL FIELD

The present disclosure relates to a refrigerant pipe used in a refrigeration cycle, and a refrigeration cycle device including the refrigerant pipe.

### BACKGROUND

A muffler is used in a refrigeration cycle. The muffler reduces driving noise and pulsating noise of a compressor transmitted to refrigerant in a refrigeration cycle, and the muffler is provided in a low-pressure refrigerant pipe located on an inlet side of the compressor.

A straight type muffler has a muffling chamber having a bulge shape, and the muffling chamber is located between an inlet pipe and an outlet pipe.

An elbow type muffler is a muffler for a hermetic compressor. Since a silencer is provided in a suction passage of the refrigerant extending from a suction pipe to a compression portion in an inside space of the hermetic compressor, pulsating noise generated in the compressing portion is reduced by the silencer.

Specifically, a communication pipe connecting the inside space and the compression portion of the compressor extends through a resonance chamber having a sealed structure, and a resonance hole open in the resonance chamber is formed in the communication pipe to form a resonance type muffling structure.

### SUMMARY

A refrigerant pipe according to a first aspect of the present disclosure includes a flow dividing portion, a first passage, a second passage, and a flow joining portion. The flow dividing portion divides a flow of refrigerant on an outlet side of an evaporator of a refrigeration cycle and on an inlet side of a compressor of the refrigeration cycle. The refrigerant divided at the flow dividing portion flows through the first passage and the second passage in parallel with each other. The refrigerant flowing through the first passage and the refrigerant flowing through the second passage join together at the flow joining portion. The first passage and the second passage are different in flow path length from each other.

A refrigeration cycle device according to a second aspect of the present disclosure includes a compressor, a radiator, a decompressor, an evaporator, and a low-pressure refrigerant pipe. The compressor draws, compresses, and discharges refrigerant. The radiator radiates heat of the refrigerant discharged from the compressor. The decompressor decompresses the refrigerant, which flows from the radiator after radiating heat in the radiator. The evaporator evaporates the refrigerant decompressed by the decompressor. The refrigerant on an outlet side of the evaporator and on an inlet side of the compressor flows through the low-pressure refrigerant pipe. The low-pressure refrigerant pipe includes a flow dividing portion, a first passage, a second passage, and a flow joining portion. The flow dividing portion divides a flow of the refrigerant. The refrigerant divided at the flow dividing portion flows through the first passage and the second passage in parallel with each other. The refrigerant flowing through the first passage and the refrigerant flowing through the second passage join together at the flow joining portion. The first passage and the second passage are different in flow path length from each other.

### BRIEF DESCRIPTION OF THE DRAWINGS

FIG. 1 is a diagram schematically illustrating an overall configuration of a refrigeration cycle device according to a first embodiment of the present disclosure.

FIG. 2 is an external view of a double pipe according to a first embodiment.

FIG. 3 is a cross-sectional diagram of the double pipe taken along III-III line according to the first embodiment.

FIG. 4 is a cross-sectional diagram of the double pipe taken along IV-IV line according to the first embodiment.

FIG. 5 is a cross-sectional diagram of a double pipe according to a second embodiment of the present disclosure.

FIG. 6 is a cross-sectional diagram of a double pipe according to a third embodiment of the present disclosure.

FIG. 7 is a cross-sectional diagram of the double pipe taken along VII-VII line according to the third embodiment.

### EMBODIMENTS

A muffler is provided in the engine room of a vehicle. When the muffler includes a muffling chamber and a resonance chamber, a mounting space for the muffler in the engine room may be large. Accordingly, since the muffler may interfere with other components in the engine room, it may not be easy to secure the space for mounting the muffler.

Further, since the pressure loss of the refrigerant may be large in the muffling chamber and the resonance chamber, the coefficient of performance (i.e. COP) of the cycle may be deteriorated.

Hereinafter, embodiments for implementing the present disclosure will be described referring to drawings. In each embodiment, portions corresponding to the elements described in the preceding embodiments are denoted by the same reference numerals, and redundant explanation may be omitted. In each of the embodiments, when only a part of the configuration is described, the other parts of the configuration can be applied to the other embodiments described above. The parts may be combined even if it is not explicitly described that the parts can be combined. The embodiments may be partially combined even if it is not explicitly described that the embodiments can be combined, provided there is no harm in the combination.

Hereinafter, embodiments will be described with reference to the drawings. In the following embodiments, identical or equivalent elements are denoted by the same reference numerals as each other in the figures.

### First Embodiment

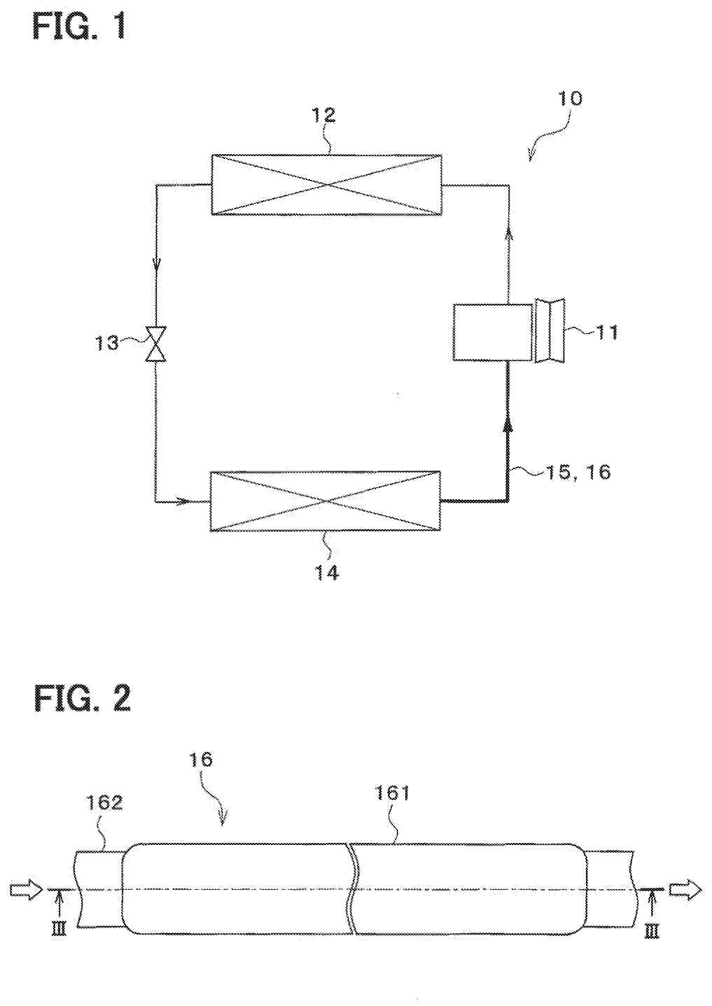

A refrigeration cycle device 10 shown in FIG. 1 is used in a vehicular air-conditioning device. The refrigeration cycle device 10 is a vapor-compression refrigerator including a compressor 11, a condenser 12, an expansion valve 13, and an evaporator 14. According to the refrigeration cycle device 10 of the present embodiment, a fluorocarbon refrigerant is adopted as the refrigerant to constitute a subcritical refrigeration cycle in which a high-pressure side refrigerant pressure does not exceed a critical pressure of the refrigerant.

The compressor 11, the condenser 12, the expansion valve 13, and the evaporator 14 are connected in series with respect to a flow of the refrigerant.

The compressor 11 draws, compresses, and discharges the refrigerant of the refrigeration cycle device 10. The compressor 11 is a belt driven type compressor or an electric compressor. The belt driven compressor may be driven when the force generated by an engine is transmitted thereto via a belt. The electric compressor is driven by power supplied from a battery. The compressor 11 is disposed inside an engine room.

The condenser 12 is a radiator that radiates heat from the high-pressure side refrigerant to the outside air by exchanging heat between the outside air and the high-pressure side refrigerant discharged from the compressor 11, and thereby the condenser 12 condenses the high-pressure side refrigerant. The condenser 12 is disposed on the vehicle front side inside the engine room.

The expansion valve 13 serves as a decompressor that is configured to decompress and expand a liquid-phase refrigerant flowing out of the condenser 12. The expansion valve 13 includes a thermosensitive portion. The thermosensitive portion is configured to detect a degree of superheat of the refrigerant proximate to an outlet of the evaporator 14 based on a temperature and a pressure of the refrigerant proximate to the outlet of the evaporator 14. The expansion valve 13 serves as a thermosensitive expansion valve that adjusts a throttle degree of a passage sectional area by a mechanical mechanism so that the degree of superheat of the refrigerant proximate to the outlet of the evaporator 14 falls within a specified range. The expansion valve 13 may be an electric expansion valve that adjusts the throttle degree of the passage sectional area by an electric mechanism.

The evaporator 14 is a cooling heat exchanger that evaporates the low-pressure refrigerant by exchanging heat between the low-pressure refrigerant flowing out of the expansion valve 13 and the air sent to the passenger compartment, and thereby the evaporator 14 cools the air sent to the passenger compartment. The gas-phase refrigerant evaporated in the evaporator 14 is drawn into and compressed by the compressor 11 through a low-pressure refrigerant pipe 15.

The evaporator 14 is housed in a casing (hereinafter, referred to as an air-conditioning casing) of an inside air-conditioning unit that is not shown. The interior air-conditioning unit is disposed on an inner side of an instrument panel (not shown) positioned front-most in the passenger compartment. The air-conditioning casing is an air-passage forming member that defines an air passage therein.

A heater core (not shown) is located downstream of the evaporator 14 in a flow direction of the air in the air passage inside the air-conditioning casing. The heater core is an air heating heat exchanger that is configured to perform a heat exchange between the engine cooling water and air supplied to the vehicle compartment thereby heating the air supplied to the vehicle compartment.

An inside-outside air switching case (not shown) and an inside blower (not shown) are arranged in the air-conditioning casing. The inside-outside air switching case serves as an inside-outside air switching unit that introduces inside air and outside air into the air passage inside the air-conditioning casing selectively. The inside blower is configured to selectively draw an inside air and an outside air introduced into an air passage defined in the air conditioning case via the inside-outside air switching case.

An air mix door (not shown) is positioned between the evaporator 14 and the heater core in the air passage inside the air-conditioning casing. The air mix door adjusts a ratio between a volume of cool air, which flows into the heater core after passing through the evaporator 14, and a volume of cool air, which bypasses the heater core after passing through the evaporator 14.

The air mix door is a rotary door that includes a rotary shaft and a door body. The rotary shaft is supported by the air-conditioning casing to be rotatable. The door body is coupled with the rotary shaft. A temperature of conditioned air, which is discharged from the air conditioning case into the passenger compartment, can be adjusted to a desired temperature by adjusting an opening position of the air mix door.

Multiple blowout openings are formed at the most downstream end of the air flow of the air-conditioning casing. The air-conditioned air whose temperature is adjusted in the air-conditioning casing is blown into the passenger compartment that is the air-conditioning target space through the blowout openings.

A blowing port mode switching door (not shown) is provided upstream of the blowout openings with respect to the air flow. The blowing port mode switching door is configured to switch the blowing port mode. The blowing port mode includes a face mode, a foot mode, and a bi-level mode, for example.

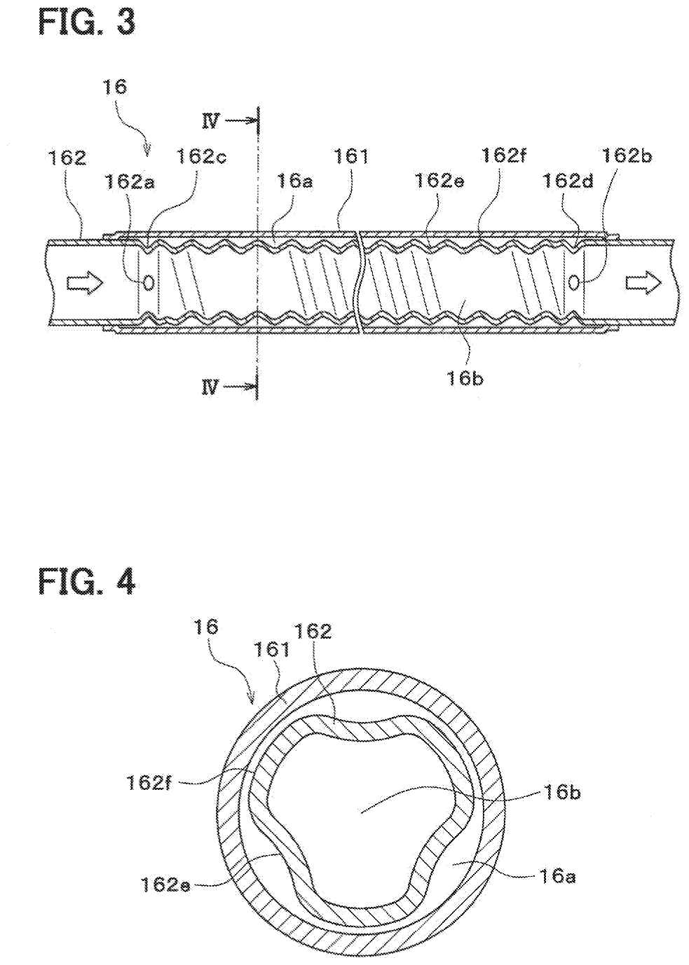

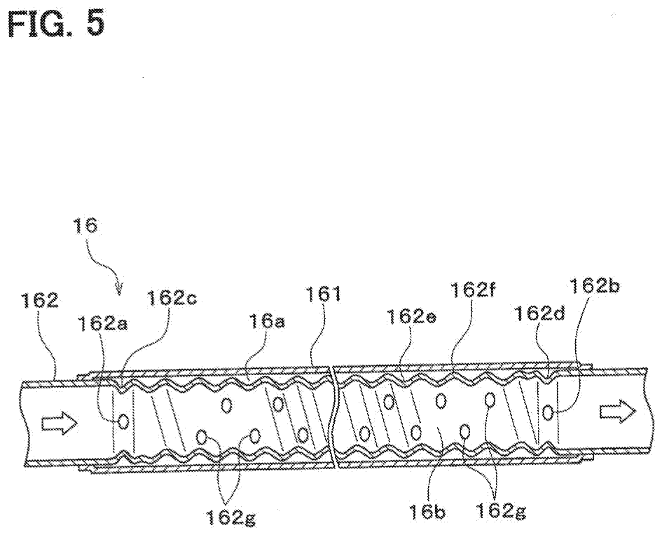

At least a part of the low-pressure refrigerant pipe 15 is constituted by a double pipe 16 shown in FIGS. 2, 3. The double pipe 16 has a length of about 700 to 900 mm and is disposed in the engine room.

The double pipe 16 includes an outer pipe 161 and an inner pipe 162, and the inner pipe 162 extends through the inside of the outer pipe 161. The outer pipe 161 is, for example, a φ22 mm pipe made of aluminum. The φ22 mm tube is a tube having an outer diameter of 22 mm and an inner diameter of 19.6 mm. The inner pipe 162 is a pipe having an outer diameter of 19.1 mm.

After the inner pipe 162 is inserted into the outer pipe 161, end portions of the outer pipe 161 in the longitudinal direction are contracted inward in the radial direction, and then the end portions are airtightly or liquid-tightly welded to the surface of the inner pipe 162.

Thereby, a space is defined between the outer pipe 161 and the inner pipe 162, and this space is the intermediate passage 16a. The internal space of the inner pipe 162 is an inside passage 16b.

The intermediate passage 16a and the inside passage 16b are refrigerant passages through which the refrigerant flows in parallel with each other. The flow path length of the intermediate passage 16a and the flow path length of the inside passage 16b are different from each other. The intermediate passage 16a is a first passage, and the inside passage 16b is a second passage.

The inner pipe 162 is, for example, a ¾ inch pipe made of aluminum. The ¾ inch pipe is a pipe having an outer diameter of 19.1 mm and an inner diameter of 16.7 mm.

The outer diameter of the inner pipe 162 is set to be close to the outer pipe 161 as long as the intermediate passage 16a is secured. Thereby, the surface area of the inner pipe 162 is increased.

A flow dividing through-hole 162a is formed in one end part of the inner pipe 162 in the longitudinal direction. A flow joining through-hole 162b is formed in the other end part of the inner pipe 162 in the longitudinal direction. The flow dividing through-hole 162a is a flow dividing portion at which the flow of the refrigerant is branched to the intermediate passage 16a and the inside passage 16b.

The flow dividing through-hole 162a and the flow joining through-hole 162b are through-holes extending through the inner pipe 162 in the radial direction. The flow dividing through-hole 162a and the flow joining through-hole 162b are flow joining portions in which the refrigerant flowing through the intermediate passage 16a joins with the refrigerant flowing through the inside passage 16b.

An inlet groove portion 162c, an outlet groove portion 162d, and a helical groove portion 162e are formed on an outer surface of the inner pipe 162.

The inlet groove portion 162c is a groove extending in a circumferential direction of the inner pipe 162 at a part of the outer surface of the inner pipe 162 at which the flow dividing through-hole 162a is provided. The outlet groove portion 162d is a groove extending in the circumferential direction of the inner pipe 162 at a part of the outer surface of the inner pipe 162 at which the flow joining through-hole 162b is provided. The inlet groove portion 162c and the outlet groove portion 162d are grooves extending in the circumferential direction of the inner pipe 162.

The helical groove portion 162e is connected with the inlet groove portion 162c and the outlet groove portion 162d. The helical groove portion 162e is a groove having multi start (in the present embodiment, triple start) and extends between the inlet groove portion 162c and the outlet groove portion 162d in the longitudinal direction of the inner pipe 162.

As shown in FIG. 4, crest portions 162f are formed between the helical groove portions 162e. The outer diameter at the crest portions is almost the same as the outer diameter of the inner pipe 162. The intermediate passage 16a is broadened by the inlet groove portion 162c, the outlet groove portion 162d, and the helical groove portion 162e.

The depth of the helical groove portion 162e is between 5% to 15% of the outer diameter of the inner pipe 162. The total length of the helical groove portion 162e is set between 300 to 800 mm.

The inlet groove portion 162c, the outlet groove portion 162d, and the helical groove portion 162e of the inner pipe 162 are formed by, for example, a grooving tool.

The helical groove portion 162e and the crest portion 162f constitute a wavy wall on the inner pipe 162. The helical groove portion 162e and the crest portion 162f constitute a wall having a bellows shape or a fold shape on the inner pipe 162.

The inner pipe 162 is spaced from the inner surface of the outer pipe 161. That is, the inner pipe 162 is not in contact with the inner surface of the outer pipe 161. A part of the inner pipe 162 in the circumferential direction may be in contact with the inner surface of the outer pipe 161.

Next, the operation with the above-described configuration will be described. When cooling is requested by the occupant, the compressor 11 is actuated, and the compressor draws the refrigerant from the evaporator 14 side, compresses the refrigerant, and discharges the high-temperature and high-pressure refrigerant toward the condenser 12. The high-pressure refrigerant is cooled by the condenser 12 and condensed to be a liquid-phase. The refrigerant here is substantially in the liquid-phase. The refrigerant that has been condensed and liquefied is decompressed and expanded by the expansion valve 131, and then the refrigerant is evaporated in the evaporator 14. The refrigerant here is in a substantially saturated gas state with a superheat degree of 0 to 3 degrees Celsius. In the evaporator 14, the conditioned air is cooled as the refrigerant evaporates. Then, the saturated gas refrigerant evaporated in the evaporator 14 flows through the low-pressure refrigerant pipe 15 as a low-temperature and low-pressure refrigerant and returns to the compressor 11.

Pressure pulsation generated as the refrigerant is drawn into the compressor 11 is propagated to the refrigerant flow in the low-pressure refrigerant pipe 15. The propagation of the pressure pulsation may cause noise in the evaporator 14.

In the double pipe 16 of the low-pressure refrigerant pipe 15, the low-pressure refrigerant is branched at the flow dividing through-hole 162a to the intermediate passage 16a and the inside passage 16b. The branched refrigerant flows in parallel with each other and join together at the flow joining through-hole 162b.

Since the intermediate passage 16a and the inside passage 16b are different in flow path length from each other, a phase difference of pulsation occurs between the refrigerant flow in the intermediate passage 16a and the refrigerant flow in the inside passage 16b, and thus the pulsation may cancel each other. Accordingly, the pulsating noise in the evaporator 14 may be reduced.

In the present embodiment, the refrigerant flow on the outlet side of the evaporator 14 and on the inlet side of the compressor 11 is branched at the flow dividing through-hole 162a. The refrigerant divided at the flow dividing through-hole 162a flows through the intermediate passage 16a and the inside passage 16b, and the refrigerant flowing through the intermediate passage 16a and the refrigerant flowing through the inside passage 16b join together at the flow joining through-hole 162b. The intermediate passage 16a and the inside passage 16b are different in flow path length from each other.

Since a phase difference of pulsation occurs between the refrigerant flow in the intermediate passage 16a and the refrigerant flow in the inside passage 16b, the pulsation is cancelled by the refrigerant flow in the intermediate passage 16a and the refrigerant flow in the inside passage 16b, and accordingly the pulsating noise can be suppressed.

Since the pulsating noise can be reduced without a noise reduction chamber or a resonance chamber, the pulsating noise from the compressor can be reduced in addition to suppressing an increase in mounting space and pressure loss as much as possible.

In the present embodiment, the low-pressure refrigerant pipe 15 includes the outer pipe 161 and inner pipe 162 constituting the double pipe 16. The intermediate passage 16a is defined between the inner pipe and the outer pipe 161, and the inside passage 16b is defined inside the inner pipe. Accordingly, the structure of the intermediate passage 16a and the inner passage 16b can be simplified.

In the present embodiment, the flow dividing through-hole 162a and the flow joining through-hole 162b are formed in the inner pipe 162 such that the intermediate passage 16a and the inside passage 16b communicate with each other through the flow dividing through-hole 162a and the flow joining through-hole 162b. Accordingly, the configurations of the flow dividing through-hole 162a and the flow joining through-hole 162b can be simplified.

In the present embodiment, the flow dividing through-hole 162a is formed in the one end portion (a first end portion) of the inner pipe 162, and the flow joining through-hole 162b is formed in the other end portion (a second end portion). Accordingly, the refrigerant can be effectively branched and joined together.

In the present embodiment, the helical groove portion 162e extending in the longitudinal direction of the inner pipe 162 is formed on the outer surface of the inner pipe 162. Accordingly, the intermediate passage 16a can be surely defined.

In the present embodiment, the helical groove portion 162e extends helically in the longitudinal direction of the inner pipe 162. Accordingly, the flow path length of the intermediate passage 16a can be surely differentiated from the flow path length of the inside passage 16b.

### Second Embodiment

In the above-described embodiment, the flow dividing through-hole 162a and the flow joining through-hole 162b are provided in the end portions of the inner pipe 162 in the longitudinal direction. In the present embodiment, multiple intermediate through-holes 162g are provided in a middle part of the inner pipe 162 in the longitudinal direction in addition to the flow dividing through-hole 162a and the flow joining through-hole 162b.

As a result, the frequency of dividing and joining of the refrigerant between the intermediate passage 16a and the inside passage 16b is increased, and accordingly the pulsation can be effectively reduced.

In the present embodiment, intermediate through-holes 162g are provided between the flow dividing through-hole 162a and the flow joining through-hole 162b. Accordingly, the refrigerant can be surely branched and joined together.

### Third Embodiment

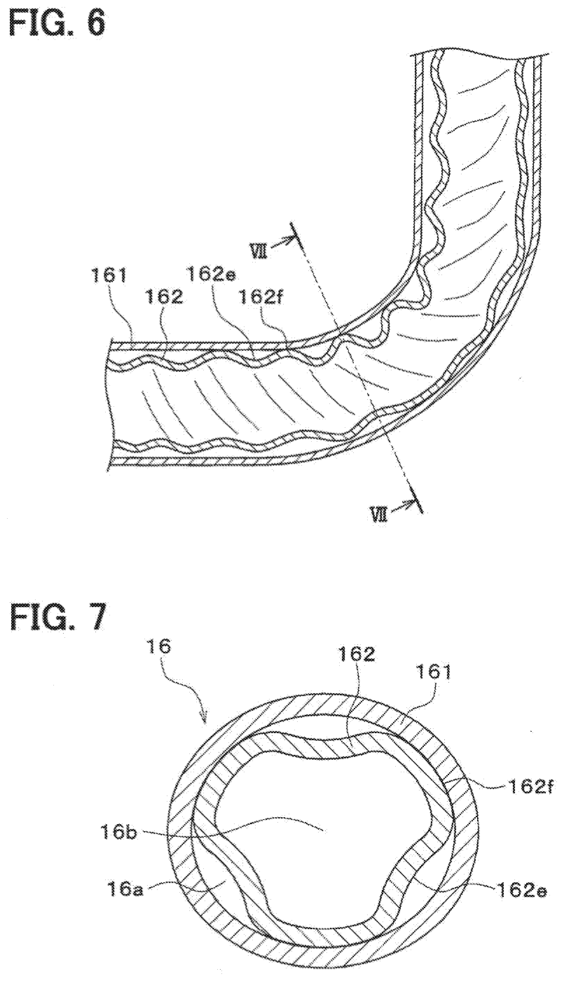

In the above-described embodiments, the double pipe 16 extends straight. In the present embodiment, the double pipe curves as shown in FIG. 6.

The double pipe 16 has multiple bent portions 163 so as to avoid interference with the engine and various devices in the engine room, the body, and the like.

The method of forming the bent portion 163 will be briefly described. First, the inner pipe 162 in which the inlet groove portion 162c, the outlet groove portion 162d, and the helical groove portion 162e are formed is inserted into the outer pipe 161. Next, the both pipes 161, 162 are bent at a predetermined part in a condition where the inner pipe 162 is inserted into the outer pipe 161. As a result, the bent portion 163 is formed.

When the bent portion 163 is formed as described above, the circular cross-sectional shape of the outer pipe 161 is deformed into a flat shape prior to the inner pipe 162. Therefore, since the inner wall of the outer pipe 161 contacts the crest portion 162f as shown in FIG. 7, the inner pipe 162 is squeezed in the radial direction and held by the outer pipe 161.

In order to ensure the above-mentioned holding state, the outer diameter of the inner pipe 162, that is, the outer diameter of the crest portion 162f is in the range of 0.7 to 0.95 or 0.8 to 0.95 times the inner diameter of the outer pipe 161.

Since the outer diameter of the crest portion 162f becomes smaller as the pitch of the helical groove portion 162e becomes smaller, it may be preferred that the pitch of the groove is at or above 12 mm such that the outer diameter of the crest portion 162f is 0.7 times or more of the inner diameter of the outer pipe 161. If the straightness of the inner pipe 162 and the outer pipe 161 is insufficient, the insertion of the inner pipe 162 into the outer pipe 161 may be difficult, and accordingly the productivity may be deteriorated. Therefore, it may be preferable that the outer diameter of the crest portion 162f is 95% or less of the inner diameter of the outer pipe 161.

The helical groove portion 162e and the crest portion 162f constitute a wavy wall on the inner pipe 162. Since the interval between the helical groove portions 162e and the interval between the crest portions 162f are narrowed in an inside part of the bent portion 163, the wavy wall in the inside part is shrunk. Since the interval between the helical groove portions 162e and the interval between the crest portions 162f are broadened in an outside part of the bent portion 163, the wavy wall in the outside part is spread out. As a result, the inner pipe 162 can be deformed inside the outer pipe 161 without exerting an excessive stress to the wall material of the inner pipe 162.

In the double pipe 16, the crest portion 162f of the inner pipe 162 at the bent portion 163 is in contact with the inner wall of the outer pipe 161, and the inner pipe 162 is squeezed and held by the outer pipe 161 in the radial direction. Accordingly, the passage between the outer pipe 161 and the inner pipe 162 is secured by the helical groove portion 162e, and the outer pipe 161 and the inner pipe 162 can be fixed by the bent portion 163 with a simple structure. Further, since the inner pipe 162 can be surely fixed, the vibration and the sympathetic vibration of the outer pipe 161 and the inner pipe 162 can be suppressed even when an external force such as vibration is applied from the vehicle. Accordingly, the contact of the pipes 161, 162 can be suppressed, and the generation of noise and damage of the pipes 161, 162 can be suppressed.

Since the groove portion of the inner pipe 162 is the helical groove portion 162e having a helical shape, the passage between the outer pipe 161 and the inner pipe 162 at the bent portion 163 is secured, and a distortion while bending can be limited. That is, the bendability of the inner pipe 162 can be improved. Since the distortion can be small, the processing force for bending the double pipe 16 can be reduced.

Since the helical groove portion 162e is a multi start groove portion, the passage between the outer pipe 161 and the inner pipe 162 can be secured even when one groove portion 162e is closed at the bent portion 163. Further, since the multi start helical groove portion 162e increases the area of the passage, the flow path resistance can be decreased.

Further, by setting the outer diameter of the outer pipe 161 to 1.1 to 1.3 times the outer diameter of the inner pipe 162, the outer pipe 161 and the inner pipe 162 can be reliably fixed at the bent portion 163.

The inner pipe 162 is firmly fixed in the outer pipe 161 at the bent portion 163d. By providing at least one bent portion 163 in the double pipe 16, the sympathetic vibration due to the vibration from the vehicle can be suppressed. As a result, noise, wear, and foreign matter generated when the outer pipe 161 and the inner pipe 162 collide with each other can be suppressed.

By providing at least one bent portion 163b within the range of 700 mm away from the end of the double pipe 16 in the longitudinal direction of the outer tube 161 and the inner tube 162, the vibration resistance of the double tube 160 can be improved.

The above-described embodiments can be appropriately combined with each other. The above-described embodiments can be variously modified as follows, for example.

The helical groove portion 162e is not limited to the triple start groove. The groove portion may be a single start, a double start, or a quad start groove, for example. A straight groove portion extending along the longitudinal direction of the inner pipe 162 may be used instead of the helical groove portion 162e.

In the above-described embodiment, the outer pipe 161 and the inner pipe 162 are made of aluminum. However, the outer pipe 161 and the inner pipe 162 may be made of iron, copper or the like.

In the above-described embodiment, the double pipe 16 provided in the refrigeration cycle device 10 is used in the vehicular air-conditioning device. However, the double pipe 16 may be used in a stationary air conditioner such as an air conditioner for a house.

In the above-described embodiment, a fluorocarbon refrigerant is used as the refrigerant for the refrigeration cycle device 10 to constitute a subcritical refrigeration cycle in which a high-pressure side refrigerant pressure does not exceed a critical pressure of the refrigerant. However, carbon dioxide may be used as the refrigerant to configure a supercritical refrigeration cycle in which the high-pressure side refrigerant pressure is equal to or higher than the critical pressure of the refrigerant.

Although the present disclosure has been described in accordance with the embodiments, it is understood that the present disclosure is not limited to such examples or structures. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A refrigerant pipe comprising:
a flow dividing portion that divides a flow of a refrigerant on an outlet side of an evaporator of a refrigeration cycle and on an inlet side of a compressor of the refrigeration cycle;
a first passage and a second passage through which the refrigerant divided at the flow dividing portion flows in parallel with each other;
a flow joining portion at which the refrigerant flowing through the first passage and the refrigerant flowing through the second passage join together; and
an outer pipe and an inner pipe constituting a double pipe, wherein
the first passage and the second passage are different in flow path length from each other,
the first passage is defined between the inner pipe and the outer pipe,
the second passage is defined inside the inner pipe,
a groove portion extending in a longitudinal direction of the inner pipe is formed on an outer surface of the inner pipe, and
the groove portion has a shape recessed radially inward from the outer surface of the inner pipe.

2. The refrigerant pipe according to claim 1, wherein
the flow dividing portion and the flow joining portion are ones of a plurality of through-holes formed in the inner pipe, the first passage and the second passage communicating with each other through the plurality of through-holes.

3. The refrigerant pipe according to claim 2, wherein
the plurality of through-holes include
a flow dividing through-hole provided in a first end portion of the inner pipe, and
a flow joining through-hole provided in a second end portion of the inner pipe.

4. The refrigerant pipe according to claim 3, wherein
the plurality of through-holes include an intermediate through-hole located between the flow dividing through-hole and the flow joining through-hole.

5. The refrigerant pipe according to claim 1, wherein
the groove portion is a helical groove portion helically extending in the longitudinal direction of the inner pipe.

6. The refrigerant pipe according to claim 1, wherein
an outer diameter of the outer pipe is at least 1.1 times and not more than 1.3 times larger than an outer diameter of the inner pipe.

7. The refrigerant pipe according to claim 1, wherein
ends of the outer pipe in the longitudinal direction are shrunk to be closely in contact with the outer surface of the inner pipe.

8. A refrigeration cycle device comprising:
a compressor that draws, compresses, and discharges a refrigerant;
a radiator that radiates heat of the refrigerant discharged from the compressor;
a decompressor that decompresses the refrigerant, which flows from the radiator after radiating heat in the radiator;
an evaporator that evaporates the refrigerant decompressed in the decompressor; and
a low-pressure refrigerant pipe through which the refrigerant on an outlet side of the evaporator and on an inlet side of the compressor flows, wherein
the low-pressure refrigerant pipe includes
a flow dividing portion that divides a flow of the refrigerant,
a first passage and a second passage through which the refrigerant divided at the flow dividing portion flows in parallel with each other, and
a flow joining portion at which the refrigerant flowing through the first passage and the refrigerant flowing through the second passage join together,
the first passage and the second passage are different in flow path length from each other,
the low-pressure refrigerant pipe includes an outer pipe and an inner pipe constituting a double pipe,
the first passage is defined between the inner pipe and the outer pipe, the second passage is defined inside the inner pipe,
a groove portion extending in a longitudinal direction of the inner pipe is formed on an outer surface of the inner pipe, and
the groove portion has a shape recessed radially inward from the outer surface of the inner pipe.

9. The refrigeration cycle device according to claim 8, wherein
the flow dividing portion and the flow joining portion are ones of a plurality of through-holes formed in the inner pipe, the first passage and the second passage communicating with each other through the plurality of through-holes.

10. The refrigeration cycle device according to claim 9, wherein
the plurality of through-holes include
a flow dividing through-hole provided in a first end portion of the inner pipe, and
a flow joining through-hole provided in a second end portion of the inner pipe.

11. The refrigeration cycle device according to claim 10, wherein
the plurality of through-holes include an intermediate through-hole located between the flow dividing through-hole and the flow joining through-hole.

12. The refrigeration cycle device according to claim 8, wherein
the groove portion is a helical groove portion helically extending in the longitudinal direction of the inner pipe.

13. The refrigeration cycle device according to claim 8, wherein
an outer diameter of the outer pipe is at least 1.1 times and not more than 1.3 times larger than an outer diameter of the inner pipe.

14. The refrigeration cycle device according to claim 8, wherein
ends of the outer pipe in the longitudinal direction are shrunk to be closely in contact with the outer surface of the inner pipe.
